(19) United States
(12) Patent Application Publication
(10) Pub. No.: US 2025/0149817 A1
(43) Pub. Date: May 8, 2025

(54) CONNECTOR DEVICE AND RECEPTACLE CONNECTOR THEREOF

(71) Applicant: DELTA ELECTRONICS, INC., Taoyuan City (TW)

(72) Inventor: Tai-Yen HSU, Taoyuan City (TW)

(21) Appl. No.: 18/648,471

(22) Filed: Apr. 28, 2024

(30) Foreign Application Priority Data
Nov. 7, 2023 (CN) 202311476223.0

(51) Int. Cl. H01R 13/05; H01R 13/62; H01R 103/00

(52) U.S. Cl. CPC H01R 13/05; H01R 13/6205; H01R 2103/00

(57) ABSTRACT

This disclosure is directed to a connector device, having a receptacle connector and a plug connector. The receptacle connector has a receptacle insulative seat, a shell and multiple receptacle terminals. The receptacle insulative seat has a tongue. The tongue has two side surfaces opposite to each other and an end surface connected between the two side surfaces. The conductive shell sleeves the receptacle insulating seat and surrounds the tongue. The conductive shell is aspirated from the tongue. The conductive shell has an opening and the end face of the tongue is disposed in the opening. The conductive shell has a magnetic attracting portion and the magnetic attracting portion is disposed at the opening. The receptacle terminals are disposed on the tongue and exposed from two side surfaces respectively, and each receptacle terminal is extended to the end surface.

### BACKGROUND OF THE DISCLOSURE

### Technical Field

This disclosure is directed to USB Type-C connectors, in particular to a connector device and a corresponding receptacle connector coupled by magnetically attracting.

### Description of Related Art

A related art of USB Type-C connector is an interface used for PD fast charging which supports a transmission with high power and high current, and capable of transmitting data, audio and images. Therefore, the USB Type-C connector has been a main interface of connector. In the European Union, in order to reduce electronic waste, a proposal of taking Type-C as a unified charging interface for all electronic devices has been approved.

The related art of USB Type C connector should pass tests of plugging/unplugging and bending during its development process. Accordingly, it is loaded with stresses in various directions when coupling and causes wear. However, a modified coupling structure with a non-contact force such as magnetic force may reduce wear and extends its life.

In views of this, in order to solve the above disadvantage, the inventor studied related technology and provided a reasonable and effective solution in this disclosure.

### SUMMARY OF THE DISCLOSURE

This disclosure is directed to a connector device capable of magnetically coupling and a corresponding receptacle connector.

This disclosure is directed to a connector device having a receptacle connector and a plug connector. The receptacle connector has a receptacle insulative seat, a shell and a plurality of receptacle terminal. The receptacle insulative seat has a tongue which has two side surfaces disposed opposite to each other and an end surface connected between the side surfaces. The shell sleeves the receptacle insulative seat. The shell is disposed to surround the tongue and spaced from the tongue. The shell has an opening, and the end surface of the tongue is located in the opening. The shell has a magnetic attracting portion, and the magnetic attracting portion is disposed in the opening. The receptacle terminals are respectively arranged on the tongue and exposed from the side surfaces, and the receptacle terminals are respectively extended to the end surface. The plug connector has a plug insulative seat, a magnetic attracting component and a plurality of plug terminals. The plug insulative seat has a coupling surface. The magnetic attracting component is disposed on the plug insulative seat. At least a part of the plug terminals is disposed on the coupling surface corresponding to a part of the receptacle terminals. The opening is defined with a coupling direction. When the plug connector is coupled with the receptacle connector, the plug insulative seat is loosely coupled to the along the coupling direction opening, the magnetic attracting component and the magnetic attracting portion are attracted with each other, the coupling surface is spaced from the end surface, and the plug terminals respectively abut against the end surface and abut against the receptacle terminals.

In an embodiment of this disclosure, the magnetic attracting portion and the magnetic attracting component are oppositely magnetic, or one of the magnetic attracting portions and the magnetic attracting component is magnetic and the other is non-magnetic and magnetizable.

In an embodiment of this disclosure, each of the receptacle terminal has a first coupling segment and a second coupling segment, the first coupling segment is exposed from one of the side surfaces of the tongue, and the second coupling segment is exposed from the end surface of the tongue.

In an embodiment of this disclosure, the end surface is non-parallel to each of the side surface, and the end surface is a convex curved surface or a polygonal convex surface.

In an embodiment of this disclosure, the tongue has a pair of lateral peripheries, each of the lateral peripheries is connected between the side surfaces and the pair of lateral peripheries are disposed at two sides of the end surface opposite to each other, a hook is arranged on each of the lateral peripheries, each hook is defined with a stopping direction opposite the coupling direction.

In an embodiment of this disclosure, a plurality of notches is defined on the coupling surface of the plug insulative seat, an elastic conductor is arranged in each of the notches, and the plug terminals are inserted in the notches correspondingly and arranged to abut against the elastic conductors correspondingly.

This disclosure is directed to a receptacle connector having a receptacle insulative seat, a shell and a plurality of receptacle terminals. The receptacle insulative seat has tongue. The tongue has two side surfaces disposed opposite to each other and an end surface connected between the side surfaces. The shell sleeves the receptacle insulative seat, and is disposed to surround the tongue and spaced from the tongue. The shell has an opening, and the end surface of the tongue is disposed in the opening. The shell has a magnetic attracting portion, and the magnetic attracting portion is disposed in the opening. The receptacle terminals are disposed on the tongue and exposed from the side surfaces respectively, and the receptacle terminals are extended to the end surface respectively.

In an embodiment of this disclosure, the magnetic attracting portion is magnetic, or non-magnetic and magnetizable.

In an embodiment of this disclosure, each of the receptacle terminals has a first coupling segment and a second coupling segment, the first coupling segment is exposed from one of the side surfaces of the tongue, and the second coupling segment is exposed from the end surface of the tongue.

In an embodiment of this disclosure, the end surface is non-parallel to each of the side surfaces. The second coupling segment is non-parallel to the first coupling segment.

In an embodiment of this disclosure, the opening is defined with a coupling direction, the tongue has a pair of lateral peripheries, each of the lateral peripheries is connected between the side surfaces and the pair of lateral peripheries are disposed at two sides of the end surface opposite to each other, a hook is arranged on each of the lateral peripheries, each hook is defined with a stopping direction opposite the coupling direction.

According to the connector device of this disclosure, when the plug connector is coupled to the receptacle connector, no friction along the coupling direction is caused between the plug connector and receptacle connector, so as to avoid wear. Moreover, the receptacle connector of this disclosure may suitable for coupling with a general USB Type-C plug connector.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing a connector device according to an embodiment of this disclosure.

FIGS. 2 to 3 are cross-sectional views showing the connector device in an operation status according to an embodiment of this disclosure.

FIGS. 4 to 5 are cross-sectional views showing the connector device in another operation status according to an embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

Detailed descriptions and technical contents of this disclosure is described in the following paragraph with reference to the drawings. However, the drawings are attached only for illustration and are not intended to limit this disclosure.

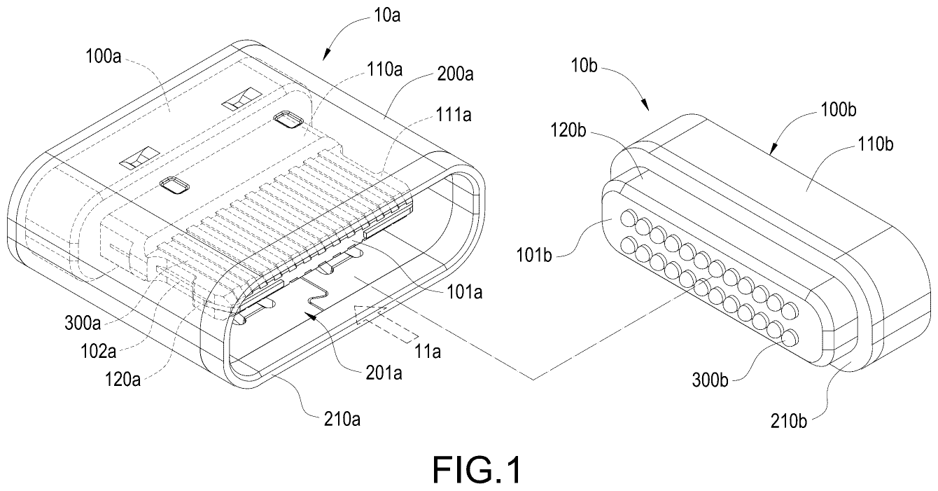

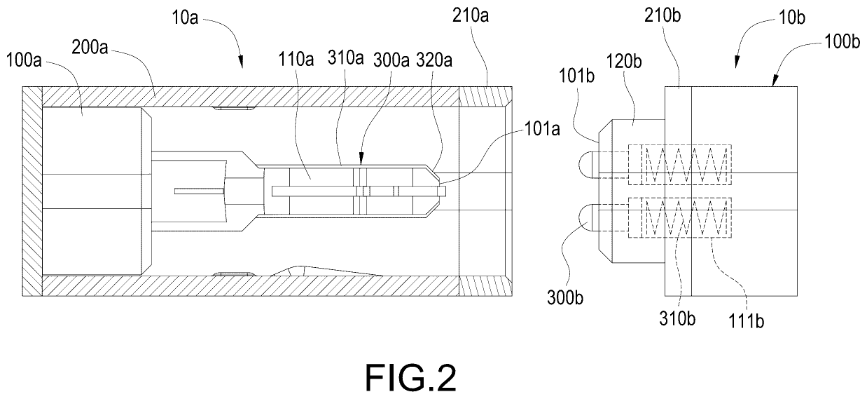

According to FIGS. 1 to 3, an embodiment of this disclosure is directed to a receptacle connector 10a which is magnetic attractable and compatible with USB type-C regulations. According to this embodiment, the receptacle connector 10a has a receptacle insulative seat 100a, a shell 200a and a plurality of receptacle terminals 300a.

According to this embodiment, the receptacle insulative seat 100a is a block made of plastic, the receptacle insulative seat 100a has a tongue 110a, the tongue 110a has geometrically compatible with the regulations of USB type-C receptacle. The tongue 110a has two side surfaces 111a disposed opposite to each other and an end surface 101a connected between the side surfaces 111a. The end surface 101a is disposed at an end of the tongue 110a and of an elongated shape, the end surface 101a is disposed non-parallel to each of the side surfaces 111a, and the end surface 101a may be a convex curved surface or a polygonal convex surface. The tongue 110a further has a pair of lateral peripheries 102a, each of the lateral peripheries 102a is connected between the side surfaces 111a, the pair of lateral peripheries 102a are disposed at two sides of the end surface 101a opposite to each other corresponding to two ends of the elongated shape of the end surface 101a.

According to this embodiment, the shell 200a is geometrically compatible with the regulars of USB type-C receptacle. The shell 200a maybe a tubular body made of metal or other materials with equivalent structural strengths, the shell 200a has an end adapted to sheathe the receptacle insulative seat 100a so as to fix the shell 200a on the receptacle insulative seat 100a. The shell 200a is disposed to surround the tongue 110a and spaced from the tongue 110a, so that the tongue 110a is accommodated in the shell 200a. The shell 200a has an opening 201a, the opening 201a is disposed at another end of the shell 200a, and the end surface 101a of the tongue 110a is disposed in the opening 201a. The aforementioned opening 201a is defined with a coupling direction 11a, and the coupling direction 11a defined to direct into the shell 200a. The shell 200a has a magnetic attracting portion 210a, and at least a part of the magnetic attracting portion 210a is located in the opening 201a, namely that the magnetic attracting portion 210a may be extended to the whole shell 200a. The magnetic attracting portion 210a may be magnetic, and the magnetic attracting portion 210a alternatively may be non-magnetic and magnetizable. The magnetic attracting portion 210a may be formed on the shell 200a or a separated part assembled to the shell 200a. Specifically, the magnetic attracting portion 210a may be a magnet assembled to the shell 200a; formed by the shell 200a which is magnetic; formed by the shell 200a made of a metal which is non-magnetic but magnetizable such as iron or stainless steel; a metal part, which is non-magnetic but magnetizable such as iron or stainless steel, assembled to the shell 200a.

The receptacle terminals 300a are arranged on the tongue 110a and respectively exposed from the side surfaces 111a of the tongue 110a so as to form an arrangement complied with the regulations of USB type-C, and each of the receptacle terminals 300a is extended to the end surface 101a of the tongue 110a. Specifically, each of the receptacle terminals 300a has a first coupling segment 310a and a second coupling segment 320a. In each of the receptacle terminals 300a, the first coupling segment 310a is exposed from one of the side surfaces 111a of the tongue 110a, the second coupling segment 320a is exposed to and disposed on the end surface 101a of the tongue 110a, and the first coupling segment 310a is disposed as an arrangement complied with the regulations of USB type-C. Specifically, each of the second coupling segments 320a may be formed as a portion of a contour of the end surface 101a, the second coupling segments 320a may be non-parallel to the first coupling segments 310a.

According to this embodiment, on each of the lateral peripheries 102a of the tongue 110a is disposed with a hook 120a, and each hook 120a has a stopping direction opposite to the coupling direction 11a. The hooks 120a are disposed with locations and geometries compatible with the regulations of USB type-C.

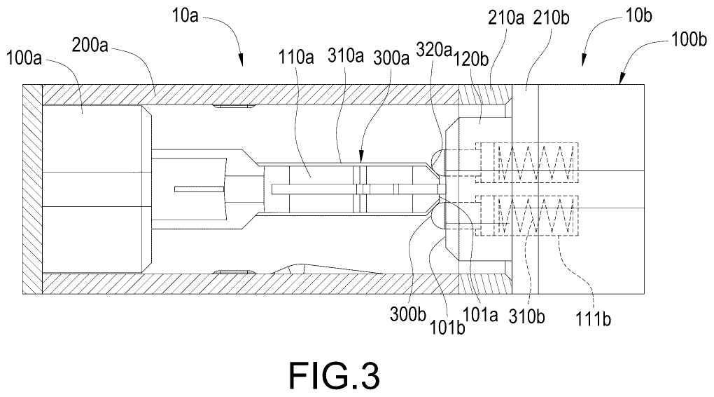

According to FIG. 3, a connector device of this disclosure has the receptacle connector 10a mentioned above and a plug connector 10b coupled therewith. Specifically, the plug connector 10b mentioned above is magnetic attractable, and has a plug insulative seat 100b, a magnetic attracting component 210b and a plurality of plug terminals. According to this embodiment the plug terminal may be pin terminals 300b, but scopes of this disclosure should not be limited to the embodiment. The plug terminal may be POGO pins or elastic metal pieces.

The plug insulative seat 100b is an insulative block made of plastic, the plug insulative seat 100b has a main body 110b and a coupling portion 120b protruding from the main body 110b, the coupling portion 120b has a contour corresponding to the opening 201a of the receptacle connector 10a, and the coupling portion 120b may be loosely plugged in to the opening 201a. The plug insulative seat 100b has a coupling surface 101b, the coupling surface 101b is located on the coupling portion 120b, and the pin terminals 300b are disposed on the coupling surface 101b corresponding to as least a part of the receptacle terminals 300a.

The magnetic attracting component 210b is arranged on the plug insulative seat 100b. The pin terminals 300b are disposed corresponding to at least a part of the receptacle terminals 300a. According to the regulations of USB Type-C, in the receptacle terminals 300a, each function is achieved by one pair of the receptacle terminals 300a, and correspondingly the pin terminal 300b can achieve a predetermined function by coupling to only one of the pair of receptacle terminals 300a. In other words, the pin terminals 300b may be one by one correspondingly equal to the receptacle terminals 300a or the pin terminal 300b may be less than the receptacle terminal 300a. For example, a number of the pin terminals 300b is half a number of the receptacle terminals 300a, and the pin terminals 300b are disposed corresponding to only half of the receptacle terminals 300a.

The magnetic attracting portion 210a and the magnetic attracting component 210b are oppositely magnetic. Alternatively, one of the magnetic attracting portions 210a and the magnetic attracting component 210b is magnetic and the other is non-magnetic but magnetizable for magnetically attracting. Accordingly, the magnetic attracting portion 210a and the magnetic attracting component 210b can be attracted with each other.

When the plug connector 10b is couple to the receptacle connector 10a, the plug insulative seat 100b is loosely coupled to the opening 201a along the coupling direction 11a, the magnetic attracting component 210b and the magnetic attracting portion 210a are attracted with each other, the coupling surface 101b and the end surface 101a are opposite to and spaced from each other, and the pin terminals 300b may be pressed on the end surface 101a of the tongue 110a by a magnetic force between the magnetic attracting component 210b, so that the each of the pin terminals 300b abut against the second coupling segment 320a of the receptacle terminals 300a correspondingly so as to electrically connect the receptacle terminal 300a correspondingly.

The pin terminals 300b may be Pogo pins, namely that a plurality of elastic conductor 310b may be disposed on the plug insulative seat 100b corresponding to the pin terminals 300b respectively. Specifically, a plurality of notches 111b are arranged on the coupling surface 101b of the plug insulative seat 100b, and in each of the notches 111b is provided with an elastic conductor 310b. The pin terminals 300b are inserted in the notches 111b correspondingly, and abuts against the elastic conductor 310b correspondingly for electrical connection so as to make sure that the pin terminals 300b respectively abut against the second coupling segments 320a of the receptacle terminal 300a correspondingly. Specifically, the second coupling segments 320a are non-parallel to the first coupling segments 310a to enlarge external surfaces thereof used for contacting the plug terminal.

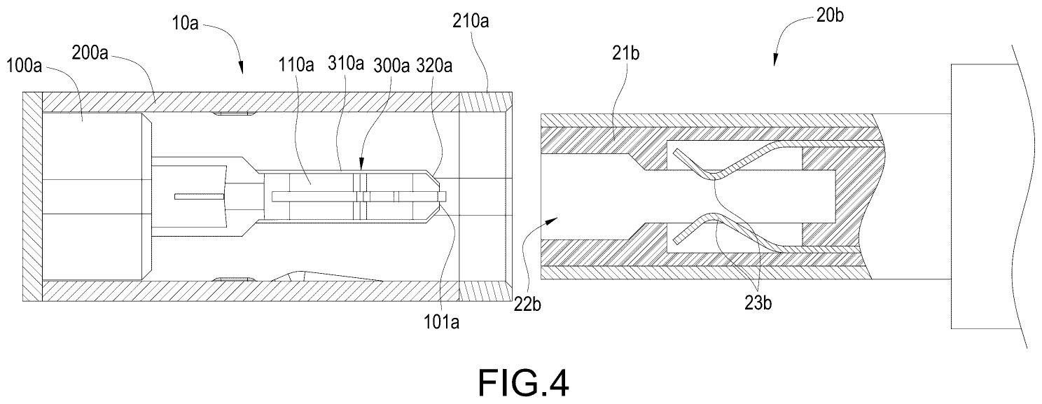

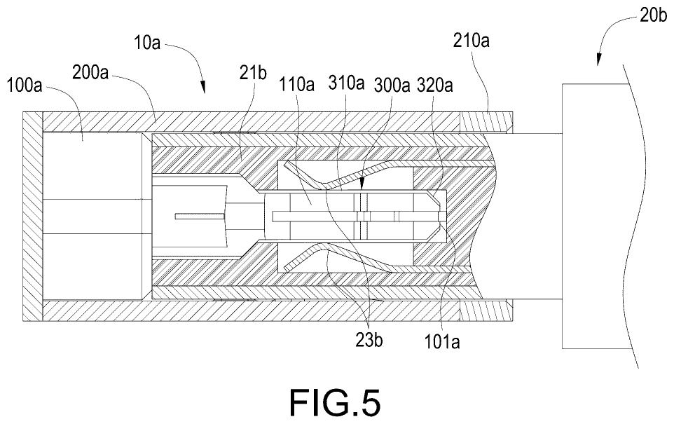

According to FIGS. 4 to 5, the receptacle connector 10a of this disclosure is compatible with a general USB Type-C plug connector 20b coupling, the general USB Type-C plug connector 20b has a plug insulative seat 21b, and the general plug insulative seat 21b has a contour compatible with the regulations of USB Type-C and therefore can plug into the shell 200a of the receptacle connector 10a mentioned above. This plug insulative seat 21b has a socket 22b, and the socket 22b has an internal contour compatible with the regulations of USB Type-C and therefore allows the tongue 110a of the aforementioned receptacle connector 10a to plug therein. Plug terminals, such as a plurality of elastic arm terminals 23b, are arranged in the socket 22b, and the elastic arm terminals 23b may be one by one correspondingly equal to the receptacle terminals 300a.

When the general USB Type-C plug connector 20b is coupled to the receptacle connector 10a of this disclosure, the elastic arm terminals 23b thereof clamp the tongue 110a of the receptacle connector 10a. Each of the elastic arm terminals 23b abut against the first coupling segment 310a correspondingly so as to electrically connect to the receptacle terminal 300a correspondingly. During the coupling of the general USB Type-C plug connector 20b to the receptacle connector 10a of this disclosure, each of the elastic arm terminals 23b scrape the first coupling segment 310a correspondingly along the coupling direction 11a. Each hook 120a of the tongue 110a of the receptacle connector 10 latches the general USB Type-C plug connector 20b to prevent loosening.

In conclusion, according to the connector device of this disclosure, there is no mechanical force between the plug connector 10b and the receptacle connector 10a along the coupling direction 11a during coupling the plug connector 10b and the receptacle connector 10a, so that the connector device of this disclosure is prevented from wear. The plug connector 10b plug will disengage with the receptacle connector 10 when a wire connected thereto is accidentally pulled during charging an electronic device so as to reduce risks of falling of the electronic equipment.

Moreover, the receptacle connector 10a of this disclosure is also suitable for coupling with the general USB Type-C plug connector 20b. It is not necessary to replace and waste the original wires.

Although this disclosure has been described with reference to the foregoing preferred embodiment, it will be understood that the disclosure is not limited to the details thereof. Various equivalent variations and modifications can still occur to those skilled in this art in view of the teachings of this disclosure. Thus, all such variations and equivalent modifications are also embraced within the scope of this disclosure as defined in the appended claims.

What is claimed is:

1. A connector device, comprising:
a receptacle connector, comprising a receptacle insulative seat, a shell and a plurality of receptacle terminals, the receptacle insulative seat comprising a tongue, the tongue comprising two side surfaces disposed opposite to each other and an end surface connected between the side surfaces, the receptacle insulative seat sheathed by the shell, the shell disposed to surround the tongue and spaced from the tongue, the shell comprising an opening and the end surface of the tongue located in the opening, the shell comprising a magnetic attracting portion disposed in the opening, the receptacle terminals disposed on the tongue, exposed from the side surfaces, and extended to the end surface; and
a plug connector, comprising a plug insulative seat, a magnetic attracting component and a plurality of plug terminals, the plug insulative seat comprising a coupling surface, the magnetic attracting component disposed on the plug insulative seat, at least a part of the plug terminals disposed on the coupling surface corresponding to a part of the receptacle terminals,
wherein the opening is defined with a coupling direction, when the plug connector is coupled with the receptacle connector, the plug insulative seat is loosely coupled to the opening along the coupling direction, the magnetic attracting component and the magnetic attracting portion are attracted with each other, the coupling surface is spaced from the end surface, and the plug terminals abut against the end surface and abut against the receptacle terminals correspondingly.

2. The connector device according to claim 1, wherein the magnetic attracting portion and the magnetic attracting component are opposite in magnetic pole, or one of the magnetic attracting portions and the magnetic attracting component is magnetic and the other one is non-magnetic and magnetizable.

3. The connector device according to claim 1, wherein each of the receptacle terminals comprises a first coupling segment and a second coupling segment, the first coupling segment is exposed from one of the side surfaces of the tongue, and the second coupling segment is exposed from the end surface of the tongue.

4. The connector device according to claim 1, wherein the end surface is non-parallel to each of the side surfaces.

5. The connector device according to claim 1, wherein the end surface is a convex curved surface or a polygonal convex surface.

6. The connector device according to claim 1, wherein the tongue comprises a pair of lateral peripheries, each of the lateral peripheries is connected between the side surfaces, the pair of lateral peripheries are disposed at two sides of the end surface opposite to each other, a hook is arranged on each of the lateral peripheries, each hook is defined with a stopping direction opposite to the coupling direction.

7. The connector device according to claim 1, wherein a plurality of notches is defined on the coupling surface of the plug insulative seat, an elastic conductor is arranged in each of the notches, the plug terminals are inserted in the notches correspondingly and arranged to abut against a plurality of elastic conductors correspondingly.

8. A receptacle connector, comprising:
a receptacle insulative seat, comprising tongue, the tongue comprising two side surfaces disposed opposite to each other and an end surface connected between the side surfaces;
a shell, adapted to sheathe the receptacle insulative seat, disposed to surround the tongue and spaced from the tongue, comprising an opening and a magnetic attracting portion, and the end surface of the tongue and the magnetic attracting portion disposed in the opening; and
a plurality of receptacle terminals, disposed on the tongue and exposed from the side surfaces, and the receptacle terminals extended to the end surface.

9. The receptacle connector according to claim 8, wherein the magnetic attracting portion is magnetic, or non-magnetic and magnetizable.

10. The receptacle connector according to claim 8, wherein each of the receptacle terminals comprises a first coupling segment and a second coupling segment, the first coupling segment is exposed from one of the side surfaces of the tongue, and the second coupling segment is exposed from the end surface of the tongue.

11. The receptacle connector according to claim 8, wherein the end surface is non-parallel to each of the side surfaces.

12. The receptacle connector according to claim 10, wherein the second coupling segment is non-parallel to the first coupling segment.

13. The receptacle connector according to claim 8, wherein the opening is defined with a coupling direction, the tongue comprises a pair of lateral peripheries, each of the lateral peripheries is connected between the side surfaces, the pair of lateral peripheries are disposed at two sides of the end surface opposite to each other, a hook is arranged on each of the lateral peripheries, and each hook is defined with a stopping direction opposite to the coupling direction.
